(19) United States
(12) Patent Application Publication
(10) Pub. No.: US 2014/0331512 A1
(43) Pub. Date: Nov. 13, 2014

(54) HEATING FURNACE AND HEATING DEVICE

(71) Applicant: Kazumi Yamashiro, Naha-shi (JP)

(72) Inventor: Kazumi Yamashiro, Naha-shi (JP)

(73) Assignees: Kazumi YAMASHIRO, Naha-shi, Okinawa (JP); RYUKOSOGYO, CO., LTD., Nago-shi, Okinawa (JP); DAIICHISANCO CONSTRUCTION CO. LTD, Itoman-shi, Okinawa (JP); PROSAP, Tokyo (JP)

(21) Appl. No.: 14/236,589

(22) PCT Filed: Aug. 2, 2012
(86) PCT No.: PCT/JP2012/069760

§ 371 Date: Mar. 13, 2014

(30) Foreign Application Priority Data
Aug. 2, 2011 (JP) PCT/JP2011/067699

(51) Int. Cl. F26B 11/04; F26B 23/02; F27B 7/02; F26B 11/02

(52) U.S. Cl. CPC F26B 11/0436; F26B 11/028; F26B 23/02; F26B 11/0445; F27B 7/02; F27B 2007/027
USPC 34/129; 34/132; 34/599; 432/112

(57) ABSTRACT

A heating furnace (56₁) comprises an inner cylindrical part (60₁) adapted to rotate about a predetermined axis (C₁), a cover part (58₁) containing the inner cylindrical part therewithin and being capable of confining heat therewithin, and a heat supply part (92) for supplying the heat into the inner cylindrical part. The inner cylindrical part includes a first end part (65A₁) located on one end side of the predetermined axis, a second end part (65B₁) located on the other end side of the predetermined axis, and a plurality of connecting members (66₁) for connecting the first and second end parts to each other and circulating an object within the inner cylindrical part as the inner cylindrical part rotates. The plurality of connecting members are discretely arranged circumferentially so as to form an opening (69₁) between the connecting members adjacent to each other.

### TECHNICAL FIELD

The present invention relates to a heating furnace and a heating device.

### BACKGROUND ART

Known as a heating furnace for heating an object to be heated is a device which feeds the object into a heating furnace and heats the object by utilizing a hot wind from a heating burner and radiation heat from an inner cylinder covering the resulting flame (see, for example, Patent Literature 1).

### CITATION LIST

### Patent Literature

Patent Literature 1: Japanese Patent Application Laid-Open No. 2006-45845

### SUMMARY OF INVENTION

### Technical Problem

In the technique disclosed in Patent Literature 1, however, the space for heating the object is directly connected to the outside through inlet and outlet ports for the object and the like, whereby the efficiency for heating the object tends to become lower.

It is therefore an object of the present invention to provide a heating furnace and a heating device which can efficiently heat an object.

### Solution to Problem

One aspect of the present invention relates to a heating device comprising a first heating furnace part for heating an object and a second heating furnace part for heating the object having passed through the first heating furnace part. In the heating device, each of the first and second heating furnace parts comprises an inner cylindrical part adapted to rotate about a predetermined axis, a cover part containing the inner cylindrical part therewithin and being capable of confining heat therewithin, and a heat supply part for supplying the heat into the inner cylindrical part. The inner cylindrical part includes a first end part located on one end side of the predetermined axis, a second end part located on the other end side of the predetermined axis, and a plurality of connecting members for connecting the first and second end parts to each other and circulating the object within the inner cylindrical part as the inner cylindrical part rotates. The plurality of connecting members are discretely arranged circumferentially so as to form an opening between the connecting members adjacent to each other.

In this structure, an object to be heated fed into the cover part in any of the first and second heating furnace parts is easily introduced into the inner cylindrical part through the opening formed between the connecting members adjacent to each other in the inner cylindrical part. The inner cylindrical part rotates about a predetermined axis, and as it rotates, the connecting members allow the object to circulate through the inner cylindrical part. Therefore, when heat is supplied into the inner cylindrical part by the heat supply part, the object circulating through the inner cylindrical part can be heated. Since the inner cylindrical part is contained in the cover capable of confining heat, the heat is hard to escape to the outside. As a result, the object circulating through the inner cylindrical part can be heated efficiently in the first and second heating furnace parts.

In one embodiment, the second heating furnace part may be disposed vertically lower than the first heating furnace part. In this mode, the second heating furnace part is arranged vertically lower than the first heating furnace part, whereby the object heated in the first heating furnace part can easily be transferred to the second heating furnace part, so as to be further heated in the latter.

In one embodiment, each of the first and second heating furnace parts in the heating device may comprise an object guide path for guiding the object within the inner cylindrical part. In this mode, the heat supply part in each of the first and second heating furnace parts may supply heat into the object guide path through a heat supply pipe. In this case, supplying the object guide path, which guides the object, with heat through the heat supply part can efficiently feed the heat to the object.

In one embodiment, one end of the heat supply part in the first heating furnace part of the heating device may be inserted into the first heating furnace part, while the other end of the heat supply part in the first heating furnace part may be inserted into the second heating furnace part. In this structure, the heat generated in the second heating furnace part can be supplied into the inner cylindrical part in the first heating furnace part through the heat supply part in the first heating furnace part.

In one embodiment, the heat supply part in the second heating furnace part may comprise a heat source. In this case, the heat source may generate heat by utilizing electricity.

Another aspect of the present invention relates to a heating furnace comprising an inner cylindrical part adapted to rotate about a predetermined axis, a cover part containing the inner cylindrical part therewithin and being capable of confining heat therewithin, and a heat supply part for supplying the heat into the inner cylindrical part. In the heating furnace, the inner cylindrical part includes a first end part located on one end side of the predetermined axis, a second end part located on the other end side of the predetermined axis, and a plurality of connecting members for connecting the first and second end parts to each other and circulating an object within the inner cylindrical part as the inner cylindrical part rotates. The plurality of connecting members are discretely arranged circumferentially so as to form an opening between the connecting members adjacent to each other.

In this structure, an object to be heated fed into the cover part is easily introduced into the inner cylindrical part through the opening formed between the connecting members adjacent to each other in the inner cylindrical part. The inner cylindrical part rotates about a predetermined axis, and as it rotates, the connecting members allow the object to circulate through the inner cylindrical part. Therefore, when heat is supplied into the inner cylindrical part by the heat supply part, the object circulating through the inner cylindrical part can be heated. Since the inner cylindrical part is contained in the cover capable of confining heat, the heat is hard to escape to the outside. As a result, the object circulating through the inner cylindrical part can be heated efficiently.

In one embodiment, the heating furnace may comprise an object guide path for guiding the object within the inner cylindrical part. In this mode, the heat supply part may supply heat into the object guide path through a heat supply pipe. In this case, supplying the object guide path, which guides the object, with heat through the heat supply part can efficiently feed the heat to the object.

### Advantageous Effects of Invention

The present invention can efficiently heat an object.

### BRIEF DESCRIPTION OF DRAWINGS

FIG. 1 is a schematic view of an embodiment of an asphalt mixture manufacturing system including an embodiment of the heating device in accordance with the present invention;

FIG. 2 is a schematic view roughly illustrating the structure of one embodiment of the heating device in accordance with the present invention;

FIG. 3 is a diagram illustrating a cross-sectional structure taken along the line III-III of FIG. 2;

FIG. 4 is an enlarged view of a cross-sectional structure of a heating furnace part arranged on the upper side in FIG. 3 in the heating device illustrated in FIG. 3;

FIG. 5 is an enlarged view of a cross-sectional structure of a heating furnace part arranged on the lower side in FIG. 3 in the heating device illustrated in FIG. 3;

FIG. 6 is a perspective view schematically illustrating an outer form of an inner cylindrical part;

FIG. 7 is an enlarged view of a region a in FIGS. 4 and 5;

FIG. 8 is a diagram illustrating an example of heat supply pipes;

FIG. 9 is a perspective view illustrating a modified example of an end part of an inner drum part;

FIG. 10 is a diagram illustrating a modified example of a connecting member having a planar scraper blade represented in FIG. 7;

FIG. 11 is a diagram illustrating a modified example of an aggregate heating device; and

FIGS. 12(a) and 12(b) are diagrams illustrating a modified example of an end part structure of a heating furnace.

### DESCRIPTION OF EMBODIMENTS

In the following, embodiments of the present invention will be explained with reference to the drawings. In the following explanations, the same constituents will be referred to with the same signs while omitting their overlapping descriptions.

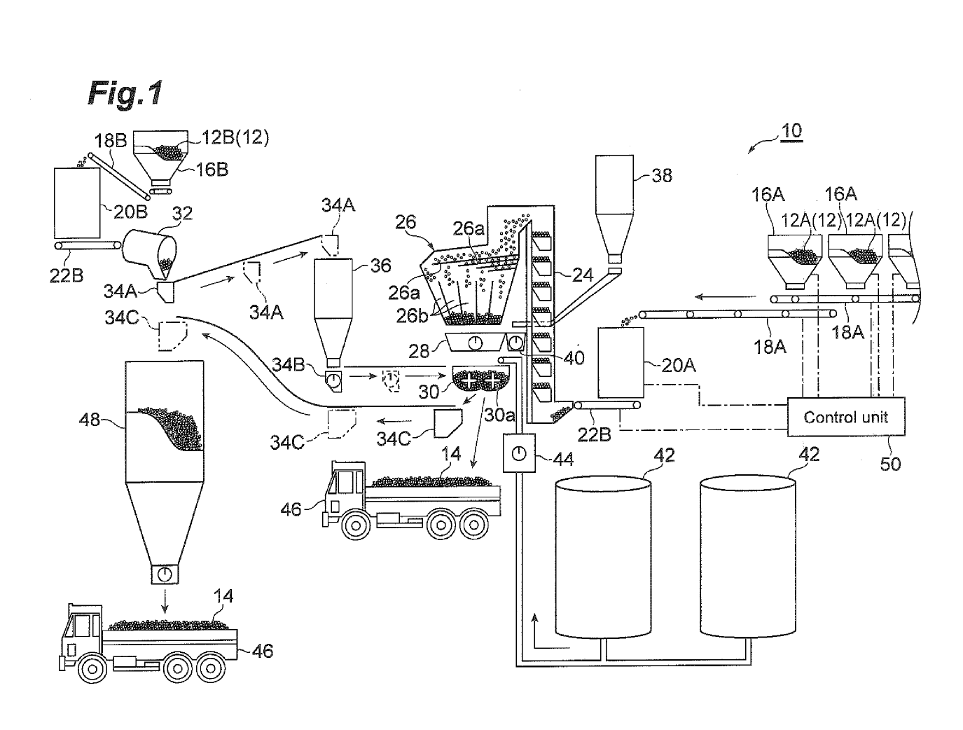

FIG. 1 is a schematic view of an embodiment of an asphalt mixture manufacturing system including an embodiment of the heating device in accordance with the present invention.

This asphalt mixture manufacturing system 10 is a system for manufacturing an asphalt mixture 14 by utilizing aggregates 12. The asphalt mixture manufacturing system 10 uses not only new aggregates 12A such as new crushed stones and new sands but also recycled aggregates 12B such as oxidizing slag as the aggregates constituting the asphalt mixture 14 and manufactures the asphalt mixture 14 by mixing the new aggregates 12A with a predetermined ratio of the recycled aggregates 12B.

The asphalt mixture manufacturing system 10 comprises a plurality of cold bins 16A for storing respective sizes of the new aggregates 12A taken out from aggregate silos stocking aggregates such as crushed stones and sands according to their sizes. A first aggregate transfer means 18A is provided under the cold bins 16A. An example of the first aggregate transfer means 18A is a conveyor. An example of the conveyor is a belt conveyor. The first aggregate transfer means 18A transfers fixed amounts of aggregates A let out of the respective cold bins 16A to an aggregate heating device 20A.

The aggregate heating device 20A heats thus supplied aggregates 12A to a desirable temperature while drying them by eliminating moistures attached thereto. A second aggregate transfer means 22B is disposed under the aggregate heating device 20A. An example of the second aggregate transfer means 22B is a conveyor. An example of this conveyor is a chain conveyor. The second aggregate transfer means 22B transfers the heated aggregates 12A let out of the aggregate heating device 10A to a hot elevator 24. The hot elevator 24 feeds the aggregates 12A into a hot bin 26. The hot bin 26, which has screens 26a for crushed stones with respective meshes corresponding to the sizes of aggregates 12A and containers 26b for containing the respective sizes of aggregates sorted by the mesh sizes of the screens 26a, sorts the aggregates 12A according to their sizes and stores them size by size.

A weighing unit 28 is disposed on the downstream side of the hot bin 26. According to amounts of compositions of the asphalt mixture 14 to be manufactured, the weighing unit 28 weighs the different sizes of aggregates 12A sorted by the hot bin 26 and then supplies them into a mixing unit 30.

The asphalt mixture manufacturing system 10 also comprises a cold bin 16B for storing the recycled aggregates 12B. Disposed under the cold bin 16B is a first aggregate transfer means 18B which is similar to the first aggregate transfer means 18A. The first aggregate transfer means 18B transfers the aggregates 12B let out of the cold bin 16B storing the aggregates 12B to an aggregate heating device 20B. The aggregate heating device 20B heats the aggregates 12B to a desirable temperature. The heated aggregates 12B are fed into a skip trolley 34A through a second aggregate transfer means 22B, which is similar to the second aggregate transfer means 22A, and a sieve 32 for recycled aggregates. The skip trolley 34A transfers the aggregates 12B to a surge bin 36. Of the aggregates 12B let out of the surge bin 36, a predetermined amount is weighed by a skip trolley 34B having a weighing function, and the predetermined amount of aggregates 12B are supplied into the mixing unit 30.

Fed into the mixing unit 30 are not only the above-mentioned aggregates 12A, 12B, but also a predetermined amount of stone powder supplied from a stone powder silo 38 and then weighed by a stone powder weighing vessel 40 and melted asphalt supplied from an asphalt tank 42, weighed by an asphalt weighing vessel 44, and then heated to a desirable temperature. Thus fed aggregates 12A, 12B, stone powder, and melted asphalt are stirred and mixed by rotary stirrer blades 30a, so as to yield the asphalt mixture 14.

The asphalt mixture 14 manufactured by the asphalt mixture manufacturing system 10 can be mounted on a transfer means 46 such as a truck, so as to be supplied directly to a site of paving. However, the asphalt mixture manufacturing system 10 may further comprise a mixture storage silo 48 for storing the manufactured asphalt mixture 14. In this case, the manufactured asphalt mixture 14 is brought into the mixture storage silo 48 through a skip trolley 34C from the mixing unit 30 and stocked in the mixture storage silo 48 so that it can be supplied to the site of paving as necessary. The asphalt mixture 14 stocked in the mixture storage silo 48 is mounted on the transfer means 46 such as a truck as appropriate, so as to be supplied to the site of paving.

For example, the amounts of aggregates 12A, 12B let out of the cold bins 16A, 16B and the aggregate heating devices 20A, 20B, the transfer rates of aggregates 12A, 12B by the first and second aggregate transfer means 18A, 18B, 22A, 22B, and the like vary depending on the desirable amount of production of the asphalt mixture 14. It is therefore preferred for the asphalt mixture manufacturing system 10 to control the amounts of aggregates let out of the devices, the transfer rates of aggregates caused by the first and second aggregate transfer means, and the like according to the desirable amount of production of the asphalt mixture 14, for example. Here, for the convenience of illustration, FIG. 1 represents that a control unit 50 is connected to the cold bin 16A, the aggregate heating device 20A, and the first and second aggregate transfer means 18A, 22A with control lines (dash-single-dot lines in the drawing), while omitting control lines to devices on the downstream side of the second aggregate transfer means 22B and devices on a line on the side of the recycled aggregates 12B.

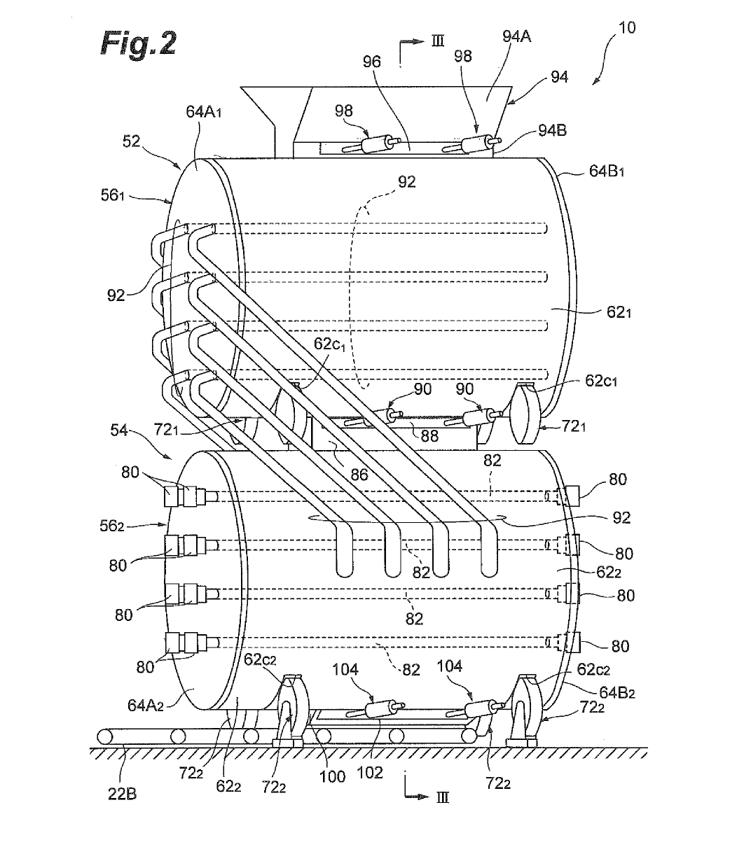

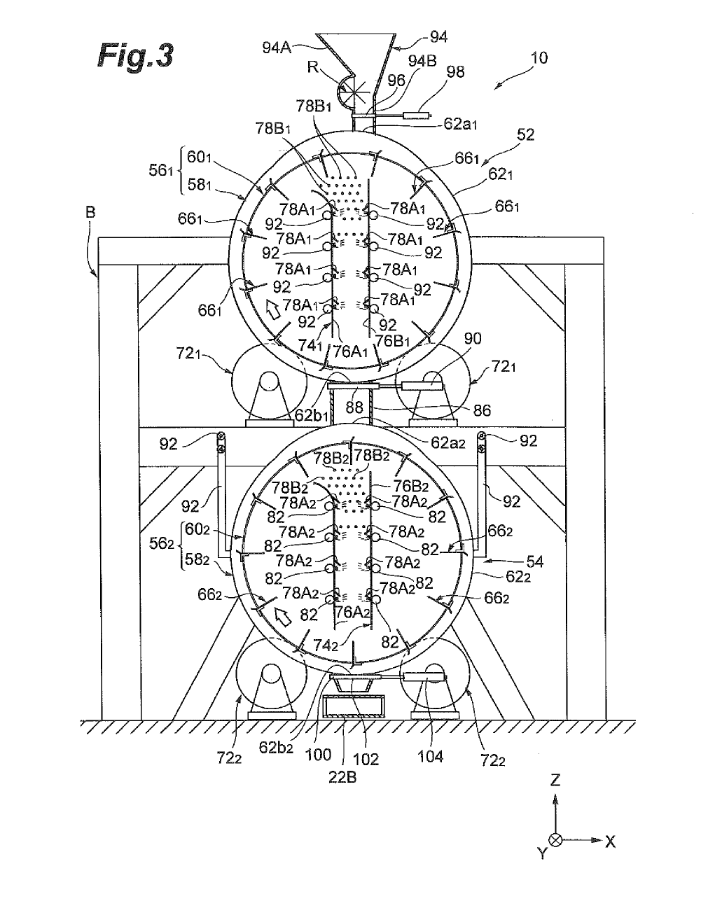

An aggregate heating device in accordance with this embodiment favorably employed in the above-mentioned asphalt mixture manufacturing system 10 will now be explained in detail with reference to FIGS. 2 and 3. In the following explanation, unless otherwise specified, the new aggregates 12A and recycled aggregates 12B will be referred to as aggregate 12, and the aggregate heating devices 20A, 20B will be referred to as aggregate heating device 20. The object heated in the aggregate heating device 20 is the aggregate 12.

FIG. 2 is a schematic structural view of one embodiment of the aggregate heating device. FIG. 3 is a schematic view of a cross-sectional structure taken along the line III-III of FIG. 2. FIG. 3 also roughly illustrates a rack B for supporting constituents of the aggregate heating device 20.

As FIGS. 2 and 3 illustrate, the aggregate heating device 20 comprises heating furnace parts (first and second heating furnace parts) 52, 54. The heating furnace part 52 is located vertically higher than the heating furnace part 54. That is, the aggregate heating device 20 has a multistage structure in which the heating furnace parts (second and first heating furnace parts) 54, 52 are provided in sequence from the vertically lower side. In the following, the vertical direction will be referred to as Z direction, while two directions orthogonal thereto will be referred to as X and Y directions, respectively, as FIG. 3 illustrates. The X and Y directions are orthogonal to each other.

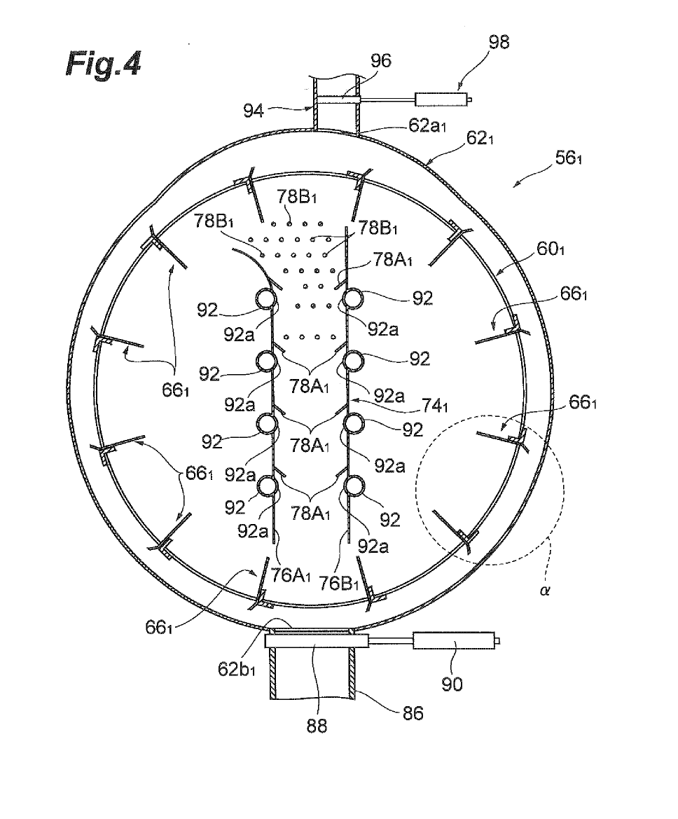

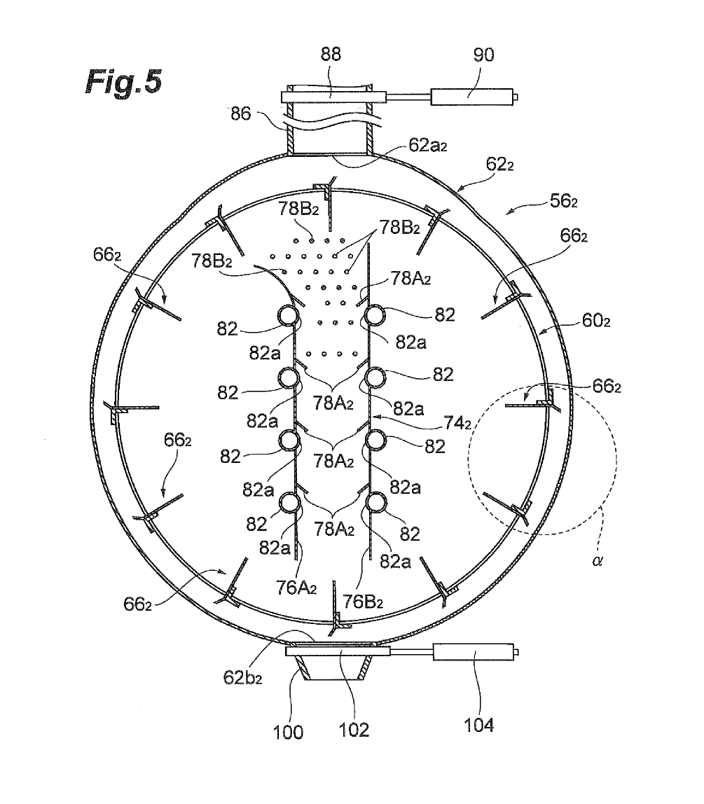

Structures of the heating furnace parts 52, 54 will now be explained. The heating furnace parts 52, 54 have heating furnaces 56ₖ, 56₂, respectively. Structures of the heating furnaces 56₁, 56₂ will be explained with reference to FIGS. 2 to 5. FIG. 4 is an enlarged view schematically illustrating a cross-sectional structure of the heating furnace 56₁. FIG. 5 is an enlarged view schematically illustrating a cross-sectional structure of the heating furnace 56₂. The heating furnaces 56₁, 56₂ have the same structure and thus will be explained in the following as heating furnace 56₁ (i=1, 2). Constituents of the aggregate heating device 20 provided so as to correspond to the heating furnaces 56₁, 56₂ will also be expressed in this manner.

The heating furnace 56ᵢ comprises a cover part 58ᵢ and an inner drum part (inner cylindrical part) 60ᵢ. The heating furnace 56ᵢ has a double structure in which the inner drum part 60ᵢ is contained within the cover part 58ᵢ.

The cover part 58ᵢ includes an outer drum part (outer cylindrical part) 62ᵢ and end walls 64Aᵢ, 64Bᵢ secured to both end parts of the outer drum part 62ᵢ. The cover part 58ᵢ is preferably made of a highly heat-insulating and tough material, an example of which is iron. The outer drum part 62ᵢ has a radius greater than that of the inner drum part 60ᵢ. As a result, the inner drum part 60ᵢ can be arranged within the cover part 58ᵢ. An example of the radius of the outer drum part 62ᵢ is 1.5 m, and the radius of the inner drum part 60ᵢ is 1.4 m in this case. A center line of the outer drum part 62ᵢ may be parallel to a center line (predetermined axis) Cᵢ of its corresponding inner drum part 60ᵢ. In this case, the outer and inner drum parts 62ᵢ, 60ᵢ extend in substantially the same direction. In the mode illustrated in FIG. 3, the outer and inner drum parts 62ᵢ, 60ᵢ extend in the Y direction. An example of the length in the extending direction (the length of Y direction) of the outer drum parts 62ᵢ is about 3.0 m. In this embodiment, the center line of the outer drum part 62ᵢ substantially coincides with the center line Cᵢ of its corresponding inner drum part 60ᵢ. The outer drum parts 62ᵢ is formed with an aggregate inlet port 62aᵢ for letting the aggregates 12 in and an aggregate outlet port 62bᵢ for letting the aggregates out. The aggregate inlet port 62aᵢ and aggregate outlet port 62bᵢ may extend in the Y direction. The cross-sectional form of the outer drum parts 62ᵢ is not limited to true circles but may bulge on the upper side near the aggregate inlet port 62aᵢ as FIG. 3 illustrates. In this case, even when the inner drum part 60ᵢ is rotating as will be explained later, the aggregates 12 let in from the aggregate inlet port 62aᵢ are easier to be introduced into the inner drum part 60ᵢ, since the outer drum part 62ᵢ is wider in the vicinity of the aggregate inlet port 62aᵢ.

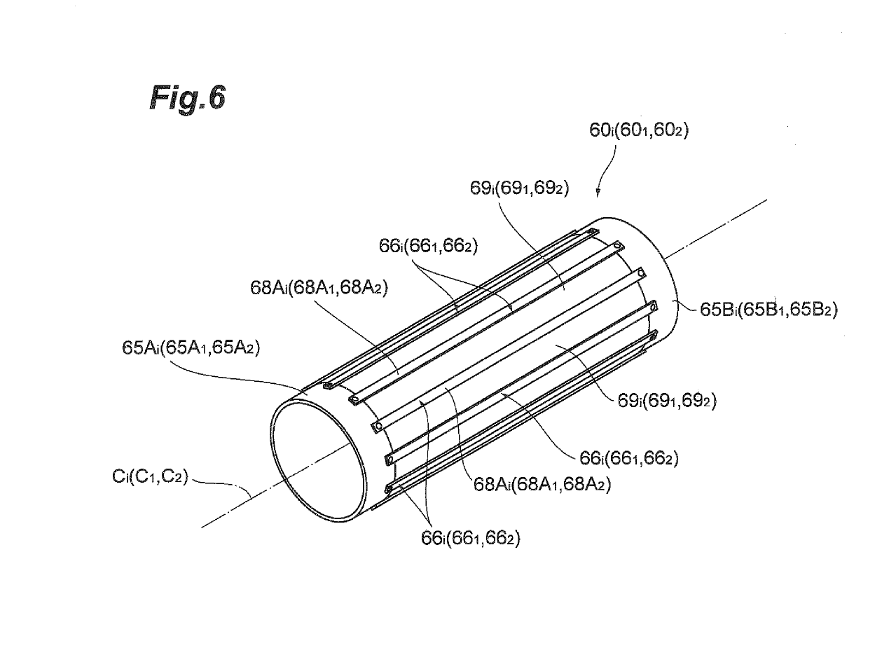

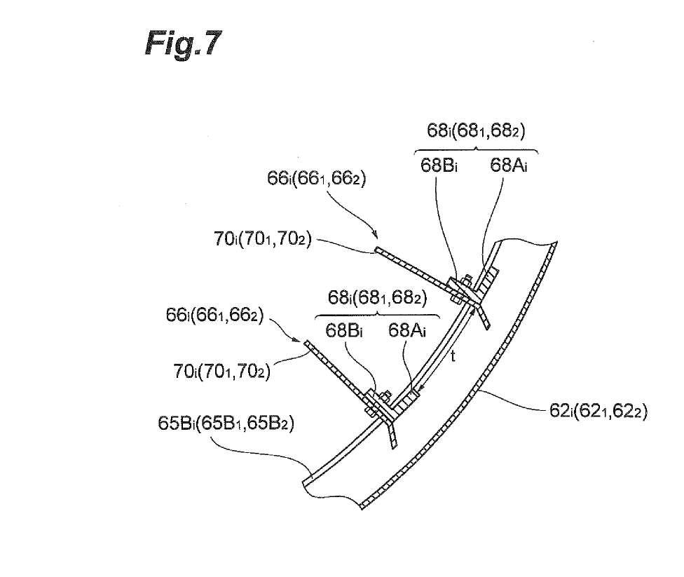

The inner drum part 60ᵢ will now be explained with reference to FIGS. 2 to 7. FIG. 6 is a perspective view schematically illustrating an outer form of the inner drum part. FIG. 7 is an enlarged view of a region α in FIGS. 4 and 5.

The inner drum part 60ᵢ has a cylindrical form. The length in the extending direction (Y direction) of the inner drum part 60ᵢ is somewhat shorter than that of the outer drum part 62ᵢ. The inner drum part 60ᵢ has annular first and second end parts 65Aᵢ, 65Bᵢ on both sides in the direction of the center line Cᵢ (Y direction in FIG. 3). The first and second end parts 65Aᵢ, 65Bᵢ are connected to each other with connecting members 66ᵢ each of which extends in the direction of the center line (predetermined axis) Cᵢ. As FIG. 6 illustrates, a plurality of connecting members 66ᵢ are discretely arranged circumferentially. Hence, fixed openings 69ᵢ are formed circumferentially between the connecting members 66ᵢ, 66ᵢ adjacent to each other. In other words, the structure of the inner drum part 60ᵢ is a skeleton structure that allows the inside to be seen between the connecting members 66ᵢ, 66ᵢ adjacent to each other. In the following, the structure of the inner drum part 60ᵢ will also be referred to as skeleton structure. The connecting member 66ᵢ can connect the first and second end parts 65Aᵢ, 65Bᵢ to each other by having respective ends fastened to the first and second end parts 65Aᵢ, 65Bᵢ with screws.

The connecting members 66ᵢ may have any number as long as they can secure such a size of the openings 69ᵢ as to introduce the aggregates 12 easily while being able to circulate the aggregates 12 within the inner drum part 60ᵢ as it rotates. For example, when the radius of the inner drum part is 1.4 m, the distance t between the connecting members 66ᵢ, 66ᵢ adjacent to each other may be about 360 mm.

The connecting member 66ᵢ has a base 68ᵢ having a first planar part 68Aᵢ extending between the first and second end parts 65Aᵢ, 65Bᵢ and a second planar part 68Bᵢ rising from an end part of the first planar part 68Aᵢ toward the inside of the inner drum part 60ᵢ (toward the center line Cᵢ). A part of the connecting member 66ᵢ projects into the inner drum part 60ᵢ. Therefore, the connecting members 66ᵢ function to catch the aggregates 12 dropping to the lower side of the inner drum part 60ᵢ as it rotates, so as to transfer or scrape them upward. Each of the first and second planar parts 68Aᵢ, 68Bᵢ may be constituted by iron, for example. The connecting member 66ᵢ may have a planar scraper blade 70ᵢ secured to the outer surface of the second planar part 68Bᵢ.

The scraper blade 70ᵢ can more efficiently catch the aggregates 12. In the scraper blade 70ᵢ, an end part on the side opposite from the center line Cᵢ may project out of the base 68ᵢ and bend away therefrom. This makes it easy for the aggregates 12 to be caught when scraped upward and to be guided to the aggregate outlet port 62bᵢ when directed to the vicinity of the lowermost portion of the inner drum part 60ᵢ. An example of materials for the scraper blade 70ᵢ is iron. The scraper blade 70ᵢ may be fastened to the second planar part 68Bᵢ with a screw, for example. The perspective view illustrated in FIG. 6 omits the scraper blades 70ᵢ.

A case where the connecting member 66ᵢ is secured to the first and second planar parts 68Aᵢ, 68Bᵢ with screws, for example, is illustrated here. However, the outer peripheral wall of a cylinder to become the outer drum part 62ᵢ may be cut out so as to form the openings 69ᵢ at predetermined circumferential intervals, thus producing the first planar parts 68Aᵢ constituting the connecting members 66ᵢ, and then the second planar parts 68Bᵢ may be secured to the first planar parts 68Aᵢ. Instead of the second planar parts 68Bᵢ, the scraper blades 70ᵢ may directly be secured to the first planar parts 68Aᵢ.

Rollers 72ᵢ (see FIG. 3) arranged in contact with the first and second end parts 65Aᵢ, 65Bᵢ rotate them, whereby the inner drum part 60ᵢ rotates about the center line Cᵢ. FIG. 3 illustrates a case of rotating the inner drum part 60ᵢ clockwise (in the direction of whitened arrows). In order for the rollers 72ᵢ to come into contact with the first and second end parts 65Aᵢ, 65Bᵢ of the inner drum part 60ᵢ placed within the cover part 58ᵢ, the outer drum part 62ᵢ of the cover part 58ᵢ is formed with apertures 62cᵢ (see FIG. 2). The number of rollers 7Z is not restricted in particular as long as the inner drum part 60ᵢ is rotated thereby.

As FIGS. 3 to 5 illustrate, each of the heating furnace parts 52, 54 may have an aggregate guide path 74ᵢ for guiding the aggregates 12 fed into the heating furnace 56₁, 56₂ from the aggregate inlet port 62aᵢ side to the aggregate outlet port 62bᵢ side. The aggregate guide path 74ᵢ may be constituted by planar path walls 76Aᵢ, 76Bᵢ opposing each other. The planar path walls 76Aᵢ, 76Bᵢ may be secured to two end walls 64Aᵢ, 64Bᵢ of the cover part 58ᵢ. Specifically, the planar path walls 76Aᵢ, 76Bᵢ may be secured to the end walls 64Aᵢ, 64Bᵢ by having both ends joined to the end walls 64Aᵢ, 64Bᵢ. The width between the path walls 76Aᵢ, 76Bᵢ is adjustable according to the amount of aggregates to be fed and the like. For example, when the inner and outer drum parts have radii of 1.4 m and 1.5 m, respectively, the width between the path walls 76Aᵢ, 76Bᵢ may be about 0.6 m. However, it is sufficient for the aggregate guide path 74ᵢ to extend between the end walls 64Aᵢ, 64Bᵢ of the cover part 58ᵢ and be open at the upper and lower faces. The aggregate guide path 74ᵢ is not required to be formed vertically but may be bent so as to obtain a fixed guide path, for example.

In the path walls 76Aᵢ, 76Bᵢ in the aggregate guide path 74ᵢ, the upper end part of the path wall on the side in which the connecting members 66ᵢ ascend as the inner drum part 60ᵢ rotates may bend outward. FIGS. 3 to 5 illustrate a case where the upper side of the path wall 76Aᵢ spreads out, since the inner drum part 60ᵢ rotates clockwise. Such a structure can guide the aggregates 12 into the aggregate guide path 74ᵢ, even if the aggregates 12 drop from a given connecting member 66ᵢ before reaching its highest point as the inner drum part 60ᵢ rotates.

The heating furnace parts 52, 54 may have diffusing means 78ᵢ for diffusing the aggregates 12 passing through the aggregate guide path 74ᵢ. The diffusing means 78ᵢ are not restricted in particular as long as they are constructed such as to diffuse the aggregates 12.

An example of the diffusing means 78ᵢ in one embodiment is constituted by thin plates 78Aᵢ adapted to vibrate vertically when a plurality of dropping aggregates 12 collide therewith. In this case, the dropping aggregates 12 collide with the thin plates 78Aᵢ and then are flipped up thereby, so as to be diffused or dispersed. The thin plates 78Aᵢ as the diffusing means 78ᵢ may be attached to the path walls 76Aᵢ, 78Bᵢ obliquely toward the lower center of the aggregate guide path 74ᵢ. In this case, the thin plates 78Aᵢ guide the aggregates 12 more toward the center of the aggregate guide path 74ᵢ. Examples of materials for the thin plates 78Aᵢ include not only metals such as iron but also carbon fiber composite materials.

Another example of the diffusing means in one embodiment may be constituted by a plurality of rods 78Bᵢ held between the two end walls 64Aᵢ, 64Bᵢ of the cover part 58ᵢ near the upper part of the aggregate guide path 74ᵢ. An example of materials for the rods 78Bᵢ is steel. Upon colliding with the plurality of rods 78Bᵢ, the aggregates 12 advance in different directions, so as to be diffused or dispersed.

While FIGS. 3 to 5 illustrate an example employing both of the thin plate 78Aᵢ and rod 78Bᵢ as the diffusing means 78ᵢ, one of them may be used alone. Other kinds of the diffusing means 78ᵢ may be provided, or a plurality of kinds of diffusing means 78ᵢ may be combined.

The heating furnace part 54 has at least one heat source 80 for supplying a hot wind for heating the aggregates 12. An example of the heat source 80 is a heater for generating the hot wind by utilizing electricity. This embodiment explains the heat source 80 as a heater.

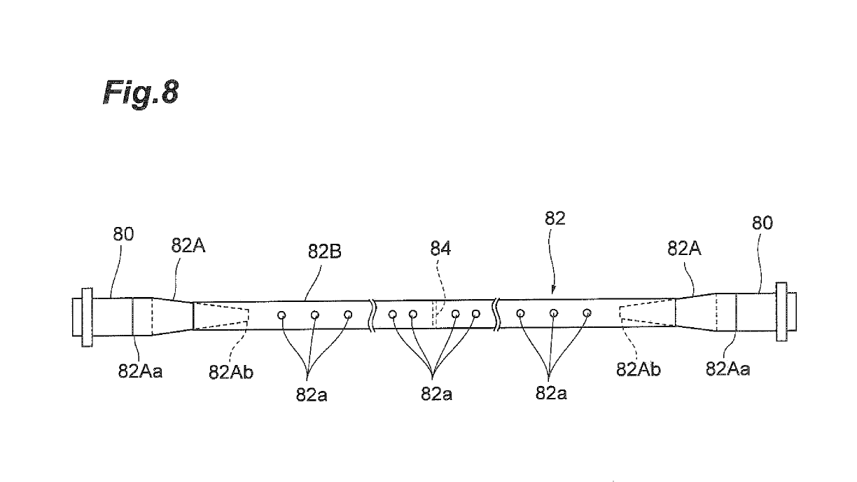

Heat supply pipes (second heat supply pipes) 82 for supplying hot winds from the heat sources 80 to the aggregates 12 are disposed between the end walls 64A₂, 64B₂ of the heating furnace part 54. The heat sources 80 and heat supply pipes 82 function as a heat supply part for supplying heat into the heating furnace part 54. However, the heat supply part is not restricted in particular as long as it can supply heat into the heating furnace part 54, specifically into the heating furnace 56₂. FIG. 8 is a schematic view roughly illustrating an example of the structure of the heat supply part with respect to the heating furnace part. As FIG. 8 illustrates, the heat sources 80 are attached to both ends of each heat supply pipe 82. As FIGS. 3 and 5 illustrate, the heat supply pipes 82 are in contact with the outer surface of the aggregate guide path 74₂. A plurality of hot wind exit ports 82a are formed on the outer surface side of the path walls 76A₂, 76B₂ in the heat supply pipes 82 in contact with the path walls 76A₂, 76B₂. Hot wind entry ports are formed in the aggregate guide path 74₂ so as to correspond to the exit ports 82a in the heat supply pipes 82. As a result, the hot winds generated by the heat sources 80 are discharged into the aggregate guide path 74₂ through the exit ports 82a and hot wind entry ports while propagating through the heat supply pipes 82. Thus, through the heat supply pipes 82, the heat supply part in the heating furnace 56₂ supplies heat into the aggregate guide path 74₂ acting as an object guide path in this embodiment.

While the embodiment depicted in FIGS. 3 to 5 illustrates a case where four heat supply pipes 82 are arranged for each of the path walls 76A₂, 76B₂, the number of heat supply pipes 82 is not restricted in particular as long as they can heat and dry the aggregates 12.

When the heat sources 80 are arranged at both ends of the heat supply pipe 82, a part of the heat supply pipe 82 may be provided with a partition 84 as FIG. 8 illustrates. In this case, the hot wind from each heat source 80 can be discharged more efficiently into the aggregate guide path 74₂ between the heat source 82 and the partition 84.

In one embodiment, as FIG. 8 illustrates, the heat supply pipe 82 may comprise a hot wind introduction part 82A and a hot wind transfer part 82B. The heat source 80 is connected to one end part 82Aa of the hot wind introduction part 82A. The diameter on the end part 82Aa side of the hot wind introduction part 82A is substantially the same as that of a hot wind output port of the heat source 80. On the other hand, the diameter of an end part 82Ab of the hot wind introduction part 82A on the side opposite from the heat source 80 is smaller than that on the heat source 80 side. The end part 82Ab is inserted in the hot wind transfer part 82B. The hot wind transfer part 82B has a substantially uniform diameter in the extending direction of the heat supply pipe 82. The diameter of the hot wind transfer part 82B is substantially the same as or greater than the end part 82Ab of the hot wind introduction part 82A but smaller than that of the end part 82Aa of the hot wind introduction part 82A.

In the mode in which the heat supply pipe 82 has the hot wind introduction part 82A and hot wind transfer part 82B as mentioned above, the hot winds supplied from the heat sources 80 are hard to return to the heat source 80 side, whereby the heat sources 80 are less likely to fail.

The heating furnace parts 52, 54 are connected to each other through an aggregate guide part 86. The aggregate guide part 86 may be made from the same material as with the cover part 58ᵢ. The aggregate guide part 86 is tubular. The aggregate guide part 86 may have a rectangular frame-like cross section substantially orthogonal to the Z direction.

A slide plate 88 engages the aggregate guide part 86 on the upper end part side thereof while being slidable in the X direction. The slide plate 88 may be made from the same material as with the cover part 58ᵢ. One end of the slide plate 88 is connected to an opening/closing controller 90 placed on the outside of the aggregate guide part 86. The opening/closing controller 90 controls the passing of the aggregates 12 through the aggregate guide part 86 by sliding the slide plate 88 in the X direction. In other words, by sliding the slide plate 88 in the X direction, the opening/closing controller 90 controls the discharging of the aggregates 12 from the heating furnace part 52 and the feeding of the aggregates 12 into the heating furnace part 54. In this case, the opening/closing of the aggregate outlet and inlet ports 62b₁, 62a₂ is substantially controlled by the slide plate 88 and opening/closing controller 90. Therefore, the slide plate 88 and opening/closing controller 90 function as an opening/closing part for the aggregate outlet and inlet ports 62b₁, 62a₂. An example of the opening/closing controller 90 is a cylinder. Examples of the cylinder include air cylinders and hydraulic cylinders. The opening/closing controller 90 is connected to the control unit 50 and controls the sliding of the slide plate 88 as instructed from the control unit 50.

The heating furnace parts 52, 54 are connected to each other through heat supply pipes (first heat supply pipes) 92 acting as a heat supply path in order to supply heat from within the heating furnace 56₂ to the heating furnace 56₁. The heat supply pipes 92 function as a heat supply part for supplying heat into the inner drum part 60₁ of the heating furnace part 52. One end of each heat supply pipe 92 is connected to the outer drum part 62₂ so as to be able to take out heat from within the heating furnace 56₂. Specifically, one end of the heat supply pipe 92 is inserted into a hole formed in the outer drum part 62₂. The heat supply pipes 92 are introduced from their junctions with the outer drum part 62₂ into the heating furnace part 52 through its end wall 64A₁. As with the heat supply pipes 82, the heat supply pipes 92 extend between the end walls 64A₁, 64B₁ along path walls of the aggregate guide path 74₁. The heat supply pipes 92 are formed with exit ports 92a on the aggregate guide path 74₁ side. Heat introduction ports are formed in the aggregate guide path 74₁ so as to correspond to the exit ports 92a. Therefore, heat discharged by the heat supply pipes 92 from within the heating furnace part 54 is ejected from the exit ports 92a through the heat introduction ports into the aggregate guide path 74₁. Thus, in this embodiment, the heat supply part in the heating furnace 56₁ supplies heat through the heat supply pipes 92 into the aggregate guide path 74₁ acting as an object guide path. The heat supply part for supplying heat to the heating furnace 56₁ is not limited to the heat supply pipes 92 as long as it can supply heat to the heating furnace 56₁. For example, the heat supply part may be a combination of heat sources and heat supply pipes as in the heating furnace 56₂.

The aggregate heating device 20 is equipped with an aggregate storage part 94 on the heating furnace part 54. The aggregate storage part 94 is connected to the aggregate inlet port 62a₁ formed in the outer drum part 62₁. The aggregate storage part 94 is a storage part for temporarily storing the aggregates 12 to be supplied to the heating furnace part 52. The aggregate storage part 94 functions as a hopper. In order to make it easy for the stored aggregates 12 to be discharged, the aggregate storage part 94 may be provided with a rotating device R having a plurality of blades attached to a rotary shaft. A slide plate 96 engages a lower end portion of the aggregate storage part 94 while being slidable in the X direction. One end of the slide plate 96 is connected to an opening/closing controller 98 placed on the outside of the aggregate storage part 94. The slide plate 96 and opening/closing controller 98 may be constructed as with the slide plate 88 and opening/closing controller 90 and thus will not be explained in detail.

As with the slide plate 88 and opening/closing controller 90, the slide plate 96 and opening/closing controller 98 substantially control the opening and closing of the aggregate inlet port 62a₁. Therefore, the slide plate 96 and opening/closing controller 98 function as the opening/closing part of the aggregate inlet port 62a₁. Since the set of the slide plate 88 and opening/closing controller 90 and the set of the slide plate 96 and opening/closing controller 98 function as the respective opening/closing parts of the aggregate outlet and inlet ports 62b₁, 62a₁, the cover part 62₁ is sealed when the slide plates 88, 90 close the aggregate outlet and inlet ports 62b₁, 62a₁. As a result, the cover part 62₁ can confine heat therein. From the viewpoint that the set of the slide plate 88 and opening/closing controller 90 and the set of the slide plate 96 and opening/closing controller 98 function as the opening/closing parts of the aggregate outlet and inlet ports 62b₁, 62a₁, the slide plate 88 and opening/closing controller 90 and the slide plate 96 and opening/closing controller 98 may be included in the cover part 62₁.

The aggregate storage part 94 has a substantially rectangular frame-like cross section orthogonal to the Z direction. As FIG. 3 illustrates, in a cross section orthogonal to the Y direction, the aggregate storage part 94 may include a taper part 94A tapering down toward the lower end portion and an aggregate guide part 94B connected to the taper part 94A. When the aggregate storage part 94 has the aggregate guide part 94B, the latter may be provided with the slide plate 96.

On the other hand, an aggregate discharge part 100 is disposed under the heating furnace part 54. The aggregate discharge part 100 is connected to the aggregate outlet port 62b₂. The aggregate discharge part 100 is tubular as with the aggregate guide part 86. The aggregate discharge part 100 may have a substantially rectangular frame-like cross section orthogonal to the Z direction. The aggregate discharge part 100 may taper down toward the lower end portion. A slide plate 102 is attached to the aggregate discharge part 100 so as to be slidable in the X direction. One end of the slide plate 102 is connected to an opening/closing controller 104 placed on the outside of the aggregate discharge part 100. The slide plate 102 and opening/closing controller 104 may be constructed as with the slide plate 88 and opening/closing controller 90 and thus will not be explained in detail.

As with the slide plate 88 and opening/closing controller 90, the slide plate 102 and opening/closing controller 104 substantially control the opening and closing of the aggregate outlet port 62b₂. Therefore, the slide plate 102 and opening/closing controller 104 function as the opening/closing part of the aggregate outlet port 62b₂. Since the set of the slide plate 88 and opening/closing controller 90 and the set of the slide plate 102 and opening/closing controller 104 function as the respective opening/closing parts of the aggregate inlet and outlet ports 62a₁, 62b₂, the cover part 62₂ is sealed when the slide plates 88, 102 close the aggregate inlet and outlet ports 62a₂, 62b₂. As a result, the cover part 62₂ can confine heat therein.

In the following, an example of methods for heating the aggregates 12 by utilizing the aggregate heating device 20 illustrated in FIGS. 2 and 3 will be explained.

The aggregate storage part 94 is closed by using the slide plate 96, so as to store the aggregates 12 therein until they reach a fixed amount (a step of storing the aggregates). At this time, the heat sources 80 in the heating furnace part 54 are driven. Heat fed into the heating furnace 56₂ by the heat sources 80 is supplied to the heating furnace part 54 through the heat supply pipes 92 as exhaust heat (hereinafter referred to as residual heat).

When the fixed amount of aggregates 12 are stored in the aggregate storage part 94, the opening/closing controller 98 slides the slide plate 96, so that the aggregate storage part 94 and the aggregate inlet port 62a₁ communicate with each other. As a consequence, the aggregates 12 within the aggregate storage part 94 pass through the aggregate inlet port 62a₁, so as to enter the heating furnace 56₁ of the heating furnace part 52. When feeding the aggregates 12 into the heating furnace 56₁, the slide plate 88 is closed. This prevents the aggregates 12 from passing through the heating furnace part 52 without being heated therein.

Given that the inner drum part 60₁ in the heating furnace 56₁ is a skeleton structure that allows the inside to be seen by having an opening 69₁ between each pair of connecting members 66₁, 66₁ adjacent to each other, the aggregates 12 fed from the aggregate inlet port 62a₁ drop through the inner drum part 60₁. Since the aggregate guide path 74₁ is arranged under the aggregate inlet port 62a₁, most of the aggregates 12 pass through the aggregate guide path 74₁.

A part of the aggregates 12 dropping through the inner drum part 60₁ are caught by inwardly projected parts of the connecting members 66₁. Specifically, when the connecting members 66₁ have the scraper blades 70₁ as FIG. 7 illustrates, the aggregates 12 are mainly caught by the scraper blades 70₁. The aggregates 12 thus caught by the connecting members 66₁ go back to the upper side of the inner drum part 60₁ as the latter rotates. The aggregates 12 returned to the upper side or scraped upward by the connecting members 66₁ drop again from the connecting members 66₁. Since the upper end portion of the aggregate guide path 74₁ is located on the upper side of the inner drum part 60₁, most of the aggregates 12 dropping after being returned to the upper side by the connecting members 66₁ drop through the aggregate guide path 74₁. Since the inner drum part 60₁ rotates, the aggregates 12 repeatedly pass through the aggregate guide path 74₁ as mentioned above.

Heat within the heating furnace 56₂ is supplied as residual heat into the aggregate guide path 74₁ through the heat supply pipes 92. The heating furnace part 54 heats the aggregates 12 with heat supplied through the heat supply pipes 92 (a step of heating the aggregates with residual heat). This heating raises the temperature of the aggregates 12, so as to remove the moisture attached to the aggregates 12, thereby drying the aggregates 12.

After the aggregates 12 are heated for a fixed time, the opening/closing controller 90 slides the slide plate 88, so that aggregate outlet and inlet ports 62b₁, 62a₂ communicate with each other. As a consequence, the aggregates 12 within the heating furnace 56₁ pass through the aggregate guide part 86, so as to enter the heating furnace 56₂. When feeding the aggregates 12 into the heating furnace 56₂, the slide plate 102 is closed. Since the heating furnace 56₂ in the heating furnace part 54 is constructed as with the heating furnace 56₁, the aggregates 12 repeatedly pass through the aggregate guide path 74₂ as the inner drum part 60₂ rotates as in the heating furnace 56₁. Hot winds from the heat sources 80 are supplied into the aggregate guide path 74₂ through the heat supply pipes 82. The heating furnace part 52 heats the aggregates 12 for a fixed time with the hot winds from the heat sources 80 (a step of heating the aggregates with the heat sources 80). This further raises the temperature of the aggregates 12.

Thereafter, the opening/closing controller 104 slides the slide plate 102, so as to open the aggregate outlet port 62b₂, whereby the aggregates 12 are let out through the aggregate discharge part 100. The aggregates 12 let out of the heating furnace part 52 are carried away by the second aggregate transfer means 22B.

In the above-mentioned aggregate heating method, the heating times in the heating furnace parts 52, 54 may be adjusted, according to the amount of aggregates 12 heated in the aggregate heating device 20 and the like, such that the aggregates 12 are dried by the heating in the lowermost heating furnace part 54 and attain a predetermined temperature.

In the aggregate heating device 20, the heating furnace 56₁ is equipped with the inner drum part 60₁ having the opening 69₁ between each pair of connecting members 66₁, 66₁ adjacent to each other. Similarly, the heating furnace 56₂ is equipped with the inner drum part 60₂ having the opening 69₂ between each pair of connecting members 66₂, 66₂ adjacent to each other. Therefore, the aggregates 12 fed into the heating furnaces 56₁, 56₂ drop through the inner drum parts 60₁, 60₂ by passing through the gap between the two connecting members 66₁, 66₁ adjacent to each other and the gap between the two connecting members 66₂, 66₂ adjacent to each other.

The aggregates 12 dropping through the inner drum parts 60₁, 60₂ are caught by the connecting members 66₁, 66₂ and, as the inner drum parts 60₁, 60₂ rotate, are transferred to the upper side again and then drop. That is, the aggregates 12 may circulate through the inner drum parts 60₁, 60₂ as the latter rotate. Therefore, the aggregate heating device 20 can heat the aggregates 12 while easily dropping them.

Since the inner drum parts 60₁, 60₂ are covered with the cover parts 58₁, 58₂, the aggregate heating device 20 inhibits the aggregates 12 from unintentionally scattering from the heating furnaces 56₁, 56₂ to the outside and dust occurring when the aggregates are scraped up from leaking out, though the inner drum parts 60₁, 60₂ have the above-mentioned skeleton structure.

As mentioned above, the aggregate inlet and outlet ports 62a₁, 62b₁ of the cover part 58₁ are substantially closed by the slide plates 96, 88, respectively. When the aggregate inlet and outlet ports 62a₁, 62b₁ are closed by the slide plates 96, 88, the cover part 58₁ is sealed, whereby heat is confined in the cover part 58₁. Similarly, the aggregate inlet and outlet ports 62a₁, 62b₁ of the cover part 58₂ are substantially closed by the slide plates 88, 102 respectively. When the aggregate inlet and outlet ports 62a₂, 62b₂ are closed by the slide plates 88, 102, the cover part 58₂ is sealed, whereby heat is confined in the cover part 58₂. As a result, though the inner drum parts 60₁, 60₂ have the skeleton structure, heat can be confined in the heating furnaces 52, 54, whereby the aggregates 12 can be heated efficiently.

Since the heating furnace parts 52, 54, which can heat the aggregates 12 more easily while dropping them, are disposed in a plurality of stages in the vertical direction, the aggregate heating device 20 can easily transfer the aggregates 12 sequentially to the lower heating furnace part, while the heating furnace parts 52, 54 can heat the aggregates 12 stepwise. This can improve processing capacity in the aggregate heating device 20.

In the embodiment of the aggregate heating device 20 illustrated in FIGS. 2 and 3, the aggregates 12 within the heating furnace part 54 are heated by the heat sources 80 that electrically generate hot winds. On the other hand, in the heating furnace part 52, the aggregates 12 are heated by heat supplied as residual heat through the heat supply pipes 92 from within the heating furnace 56₂. Therefore, without generating CO₂ itself, the aggregates 12 can be dried and heated in the heating furnace part 54 and dried in the heating furnace part 52. Hence, the aggregate heating device 20 and the aggregate heating method utilizing the aggregate heating device 20 can more securely prevent the environment from being destroyed.

The aggregate heating device 20 having the multistage structure can efficiently heat the aggregates 12, since the aggregates 12 dried by removing moisture at least partly therefrom in the heating furnace part 52 are heated in the heating furnace part 54. The aggregates 12 can further be heated with heat or steam naturally generated from the aggregates 12 themselves upon heating thereof within the heating furnace parts 52, 54. Hence, the aggregate heating device 20 and the aggregate heating method utilizing the aggregate heating device 20 can dry and heat the aggregates 12 with saved energy. When the heating furnace parts 52, 54 are provided in a plurality of stages in the vertical direction, the efficiency in processing the aggregates 12 can be improved by effectively utilizing a space even when the place for installing the aggregate heating device 20 is limited.

In the embodiment in which the heating furnace parts 52, 54 are equipped with the aggregate guide paths 74₁, 74₂ as object guide paths, most of the aggregates 12 pass through the aggregate guide paths 74₁, 74₂. Therefore, supplying heat into the aggregate guide paths 74₁, 74₂ can efficiently heat the aggregates 12. When the diffusing means 78₁, 78₂ for diffusing the aggregates 12 are further provided in the embodiment equipped with the aggregate guide paths 74₁, 74₂, the aggregates 12 are diffused or dispersed by the diffusing means 78₁, 78₂ and thus can be heated more efficiently.

As FIGS. 3 and 5 illustrate, when hot winds from the heat sources 80 are supplied into the aggregate guide path 74₂ through the heat supply pipes 82 arranged along the outer surface of the aggregate guide path 74₂, the aggregates 12 passing through the aggregate guide path 74₂ can efficiently be fed with the hot winds. As a result, the aggregates 12 can be heated more efficiently in the heating furnace part 54. When heat is supplied from within the heating furnace 56₂ to the aggregate guide path 74₁ through the heat supply pipes 92, the aggregates 12 passing through the aggregate guide path 74₁ can efficiently be heated with the residual heat in the heating furnace 56₂, so as to be dried.

While an embodiment of the heating device and heating furnace in accordance with the present invention is explained in the foregoing, the present invention is not limited thereto but may be modified in various manners within the scope not deviating from the gist thereof.

The aggregate heating device (heating device) 20 illustrated in FIGS. 2 and 3 exemplifies a case where one heating furnace part 54 for heating the aggregates 12 with the heat sources 80 is provided in the vertical direction. However, the number of heating furnace parts 54 may also be 2 or more. When there is one heating furnace part 52 for a plurality of heating furnace parts 54, heat as residual heat from a plurality of heating furnace parts 54 may be supplied to the heating furnace part 52.

Two or more heating furnace parts 52 may also be provided in the vertical direction. In this case, each heating furnace part may be supplied with heat from one or a plurality of heating furnace parts 54. Alternatively, one heating furnace part having received heat from the heating furnace part 54 may further supply the heat to another heating furnace part.

In the aggregate heating device 20 illustrated in FIGS. 2 and 3, the heat sources 80 are connected to both ends of the heat supply pipe 82. However, the heat source 80 may be attached to one end of the heat supply pipe 82 alone. In the pair of ends of the heat supply pipe 82 in this case, the end that is free of the heat source 80 may be either opened or closed.

The aggregate heating device 20 illustrated in FIGS. 2 and 3 exemplifies a mode in which one end of the heat supply pipe 92 is connected to the outer drum part 62₂. However, it is sufficient for the end on the heating furnace 56₂ side of the heat supply pipe 92 to be connected to the heating furnace 56₂ such as to be able to take out heat from therewithin. Therefore, one end of the heat supply pipe 92 may be inserted into the heating furnace 56₂ from the end wall 64A₂, for example.

When the heating furnace 56₁ is equipped with the aggregate guide path 74₁, in the heat supply pipes 92, a part extending along the path walls 76A₁, 76B₁ (a part within the heating furnace 560 may serve as heat supply pipes. In this case, it is sufficient for an end of each heat supply pipe located in the part within the heating furnace 56₁ to be connected to one end of a connecting pipe which has the other end connected to the inside of the heating furnace 56₂ and is adapted to guide heat. Alternatively, a heat source may be connected to an end of the heat supply pipe located in the part within the heating furnace 56₁.

While FIGS. 3, 4, and 5 illustrate a mode in which the heating furnaces 56₁, 56₂ have the aggregate guide paths 74₁, 74₂, the heating furnaces 56₁, 56₂ may be free of the aggregate guide paths 74₁, 74₂. In this case, the heat supply part in the heating furnace part 54 may be used as a heat source, while the heat supply part in the heating furnace part 52 may serve as a heat supply path for introducing heat from within the heating furnace 56₂ into the heating furnace 56₁. The heat supply part in the heating furnace part 52 may also be a heat source.

In the structure equipped with the aggregate storage part, heat may be supplied from at least one of the heating furnace parts to the aggregate storage part through the heat supply path. In this case, the aggregates stored in the aggregate storage part are heated, whereby the aggregates can be heated and dried more efficiently.

When a plurality of heating furnace parts 52 are provided for a plurality of heating furnace parts 54, the exhaust heat of a plurality of heating furnace parts 54 may be distributed to the heating furnace parts 52 according to a desirable heating state in each heating furnace part 52.

An example of the heat sources 80 that generate heat by utilizing electricity is not limited to heaters. For example, the heat sources 80 may generate steam by utilizing electricity, and the heating furnace part 54 may heat the aggregates 12 with steam generated by the heat sources 80. Another example of the heat sources 80 may comprise a device for generating a hot wind by utilizing electricity and a device for generating steam by utilizing electricity. The heat sources 80 are not limited to those generating heat by utilizing electricity as long as they generate heat. Heating burners are also employable as the heat sources 80.

The aggregate heating device 20 illustrated in FIGS. 2 to 4 is equipped with the aggregate storage part 94. However, the aggregate storage part 94 may be omitted. In this case, the aggregates 12 from the first aggregate transfer means 18A or the first aggregate transfer means 18B may directly be fed into the heating furnace part 52.

The aggregate guide part 86 is provided in the embodiment illustrated in FIGS. 2 to 4. However, the aggregate guide part 86 may be omitted. In this case, the heating furnace parts adjacent to each other may directly be connected to each other.

The aggregate inlet and outlet ports 62a₁, 62b₁ are not required to be arranged vertically with respect to each other as illustrated in FIG. 3 as long as the aggregates 12 fed from the aggregate inlet port 62a₁ can be let out of the aggregate outlet port 62b₁ side. The same holds for the arrangement of the aggregate inlet and outlet ports 62a₂, 62b₂ with respect to each other.

While the control by the control unit 50 regulating the asphalt mixture manufacturing system as a whole is illustrated as control for the aggregate heating device 20, the aggregate heating device 20 may be equipped with a control unit, for example.

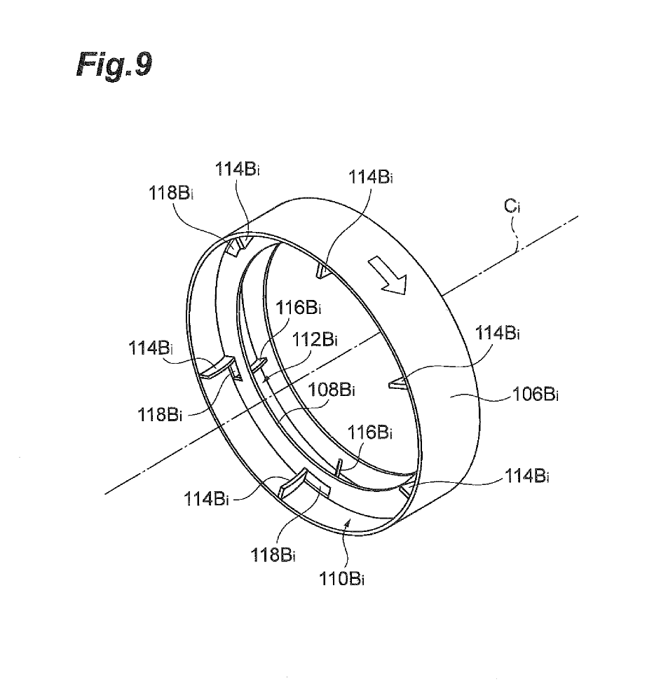

FIG. 9 is a perspective view illustrating a modified example of an end part of the inner drum part. FIG. 9 schematically illustrates a second end part 106Bᵢ as a modified example of the second end part 65Bᵢ depicted in FIG. 6.

As FIG. 9 illustrates, a partition 108Bᵢ divides the cylindrical second end part 106Bᵢ into two in the direction of the center line Cᵢ. The partition 108Bᵢ circles once around the inner peripheral surface of the second end part 106Bᵢ. For convenience of explanation, in the second end part 106Bᵢ, the regions located on the first end part side and the side opposite thereto as seen from the partition 108Bᵢ will be referred to as inner and outer regions 110Bᵢ, 112Bᵢ, respectively.

The inner diameter of the second end part 106Bᵢ is smaller at the opening end in the outer region 112Bᵢ (the outer opening end in the direction of the center line Cᵢ) and at the partition 10Bᵢ than at the opening end on the inner region 110Bᵢ side. In one embodiment, the inner diameter of the second end part 106Bᵢ at the opening end on the outer region 112Bᵢ side may be equal to or smaller than that at the partition 108Bᵢ.

Return blades 114Bᵢ are discretely provided in the inner region 110Bᵢ circumferentially thereof. Each return blade 114Bᵢ is arranged so as to intersect the circumferential direction. Similarly, a plurality of return blades 116Bᵢ are provided in the outer region 112Bᵢ so as to correspond to the respective return blades 114Bᵢ. Each return blade 116Bᵢ is arranged so as to intersect the circumferential direction. In one embodiment, the return blades 116Bᵢ are arranged substantially parallel to their corresponding return blades 114Bᵢ.

Each return blade 114Bᵢ and its corresponding return blade 116Bᵢ are circumferentially separated from each other, so that the return blade 116Bᵢ is located on the front side in the rotating direction of the inner drum part 60ᵢ (in the direction of the whitened arrow in FIG. 9). An opening part 118Bᵢ is circumferentially formed in a region in the partition 108Bᵢ between each pair of the return blades 114Bᵢ, 116Bᵢ corresponding to each other.

When heating the aggregates 12 within the heating furnace 56ᵢ by using the inner drum part 60ᵢ equipped with the second end part 106Bᵢ, the partition 108Bᵢ makes the aggregates 12 harder to flow to the outer region 112Bᵢ side. Even if the aggregates 12 flow to the outer region 112Bᵢ side, the aggregates 12 will move to the position of the return blade 116Bᵢ as the inner drum part 60ᵢ rotates. The aggregates 12 stopped by the return blade 116Bᵢ from moving will flow into the inner region 110Bᵢ again through the opening part 118Bᵢ and then will be returned to the first end part side (toward the center of the inner drum part 60ᵢ in the direction of the center line Cᵢ) by the return blade 114Bᵢ.

The positions of the return blades 114Bᵢ, 116Bᵢ may be adjusted so as to make it easy for the aggregates 12 to return from the outer region 112Bᵢ to the inner region 110Bᵢ through the opening part 118Bᵢ. For example, the return blades 114Bᵢ, 116Bᵢ may be tilted with respect to the direction of the center line Cᵢ.

The structure of the second end part 106Bᵢ and its operational effects explained here also hold for the first end part paired therewith.

Therefore, when the inner drum part 60ᵢ employs the second end part 106Bᵢ and the first end part paired therewith, the aggregates 12 flowing into both end parts of the inner drum part 60ᵢ can efficiently be returned to the inside in the direction of the center line Cᵢ. This can more securely prevent the aggregates from flowing out of paths other than their originally assumed outlet path. In this case, structural parts for rotating the inner drum part 60ᵢ are less likely to be clogged and so forth with the aggregates 12 unnecessarily staying in the heating furnace 56ᵢ after flowing out of the inner drum part 60ᵢ from paths other than their assumed outlet path. This makes it easy for the inner drum part 60ᵢ to rotate stably and smoothly.

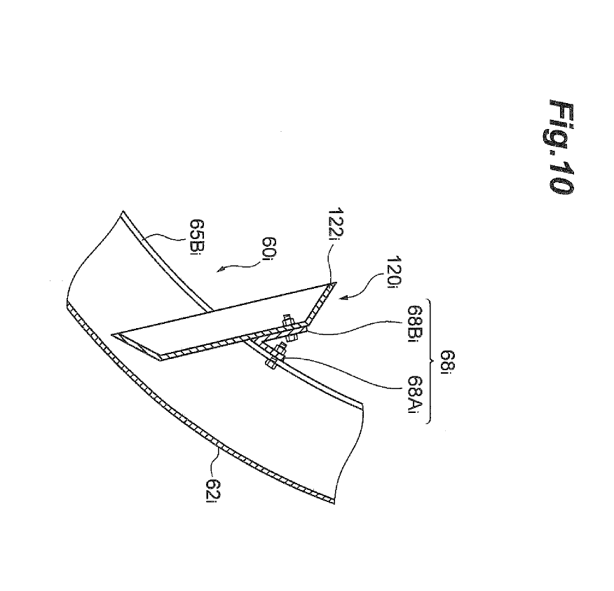

FIG. 10 is a diagram illustrating a modified example of a connecting member having a planar scraper blade represented in FIG. 7. As FIG. 10 illustrates, a connecting member 120ᵢ which is another example of the connecting member 66ᵢ has a dish-shaped scraper blade 122ᵢ in place of the planar scraper blade 70ᵢ. The scraper blade 122ᵢ is arranged such that its opening part is located on the front side in the rotating direction of the inner drum part 60ᵢ. In FIG. 10, the inner drum part 60ᵢ rotates clockwise. For example, the scraper blade 122ᵢ may be tilted with respect to the radial direction of the inner drum part 60ᵢ as illustrated in FIG. 10. In this case, the first and second planar parts 68Aᵢ, 68Bᵢ form an acute angle therebetween.

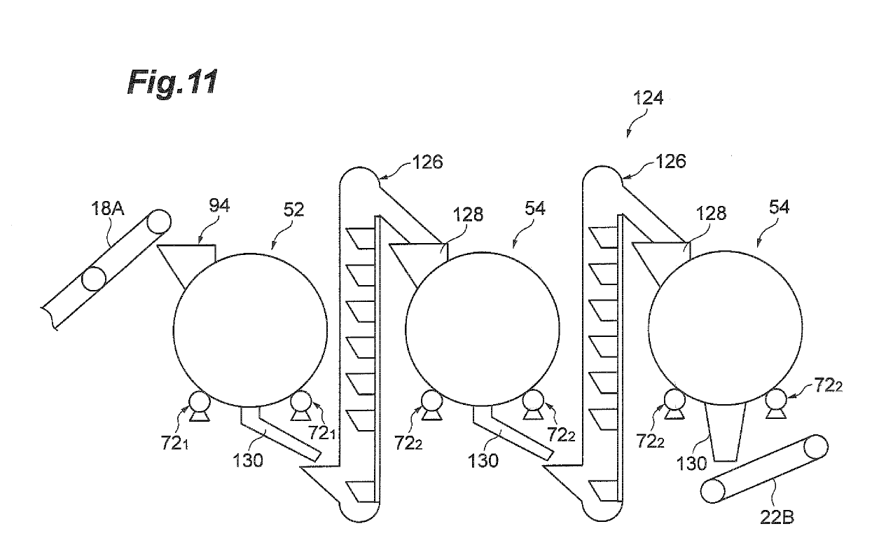

FIG. 11 is a diagram illustrating a modified example of the aggregate heating device. The aggregate heating device 124 illustrated in FIG. 11 differs from the aggregate heating device 20 depicted in FIG. 2 mainly in that it comprises a heating furnace part 52 and two heating furnace parts 54, which are arranged substantially parallel to the horizontal direction.

The heating furnace parts 52, 54 in the aggregate heating device 124 are constructed as in the aggregate heating device 20 and thus are schematically illustrated in FIG. 11 without explanations.

The aggregate heating device 124 is equipped with hot elevators 126 between the heating furnace parts 52, 54 and between the heating furnaces 54, 54. Each hot elevator 126 functions as a transfer means (transfer mechanism) for transferring the aggregates 12 heated in the upstream heating furnace part to the downstream heating furnace part. FIG. 11 illustrates the hot elevator 126 as the transfer mechanism. However, the transfer mechanism is not limited to hot elevators as long as it is a mechanism which can transfer the aggregates 12 heated in the upstream heating furnace part to the downstream heating furnace part.

An aggregate introduction part 128 for introducing the aggregates 12 from the hot elevator 126 into the aggregate inlet port 62aᵢ is attached to the upper side of each heating furnace part 54. The aggregate introduction part 128 may have a rectangular frame-like cross section in the Z direction (vertical direction) as with the aggregate storage part 94. The aggregate introduction part 128 functions as a hopper. Its end part on the hot elevator 126 side may be widened as illustrated in FIG. 11 from the viewpoint of more securely receiving the aggregates 12 from the hot elevator 126.

In one embodiment, tubular aggregate outlet paths 130 for the aggregates 12 let out of the heating furnace parts 52, 54 to flow into the hot elevators 126 may be attached to the heating furnace parts 52, 54. An example of the aggregate outlet paths 130 is a so-called chute. For example, the aggregate outlet path 130 may be attached to the heating furnace part 52 in place of the aggregate guide part 88 (see FIG. 4) communicating with the aggregate outlet port 62B₁ of the heating furnace part 52 or so as to cover the aggregate guide part 88. Similarly, for example, the aggregate outlet path 128 may be attached to the heating furnace part 54 in place of the aggregate discharge part 100 (see FIG. 5) or so as to cover the aggregate discharge part 100. The aggregate outlet paths 128 may have any forms as long as they can favorably make the aggregates 12 flow to respective transfer means, disposed on the downstream of the heating furnace parts 52, 54, for transferring the aggregates 12.

Mechanisms for letting the aggregates 12 into the heating furnace parts 52, 54 and mechanisms for letting the aggregates 12 out of the heating furnace parts 52, 54 may be constructed as in the aggregate heating device 10.

In the aggregate heating device 124, each heating furnace part 54 may be connected to the heating furnace part 52 with the heat supply pipes (heat supply part) 92, for example. In this case, the heating furnace part 52 is supplied with heat (residual heat) from the two heating furnace parts 54 and heats the aggregates 12 with the heat from the heating furnace parts 54 as in the aggregate heating device 10.

In the aggregate heating device 124, the aggregates 12 heated (preheated) in the heating furnace part 52 is transferred to its adjacent heating furnace part 54 by the hot elevator 126. The heating furnace part 54 adjacent to the heating furnace part 52 further heats the aggregates 12 from the hot elevator 126 and then discharges them. The aggregates 12 heated in the heating furnace part 54 is transferred to its adjacent heating furnace part 54 and further heated there. The aggregates 12 heated in the final heating furnace part 54 in the aggregate heating device 124 illustrated in FIG. 11 is discharged from the heating furnace part 54 to the second aggregate transfer means 22B and carried away by the latter.

The heating furnace parts 52, 54 in the aggregate heating device 124 are constructed as in the aggregate heating device 10, i.e., the inner drum part 60ᵢ is covered with the cover part 58ᵢ. Therefore, the heating furnace parts 52, 54 in the aggregate heating device 124 have at least the same operational effects as with the heating furnace parts 52, 54 in the aggregate heating device 10.

When the heating furnace parts 52, 54 are arranged horizontally as FIG. 11 illustrates, the aggregate heating device 124 can easily be placed while taking account of its aseismic reinforcement and the like, whereby the manufacturing cost of the aggregate heating device 124 can be cut down.

While the heating furnaces 52, 54, 54 are arranged horizontally in the structure illustrated in FIG. 11, vertical arrangement as illustrated in FIG. 2 and horizontal arrangement may be combined. While two heating furnace parts 54 are arranged for the heating furnace part 52 in the structure illustrated in FIG. 11, the numbers of heating furnace parts 52, 54 are not limited in particular as long as they can finally heat the aggregates 12 to a desirable temperature or dry the latter.

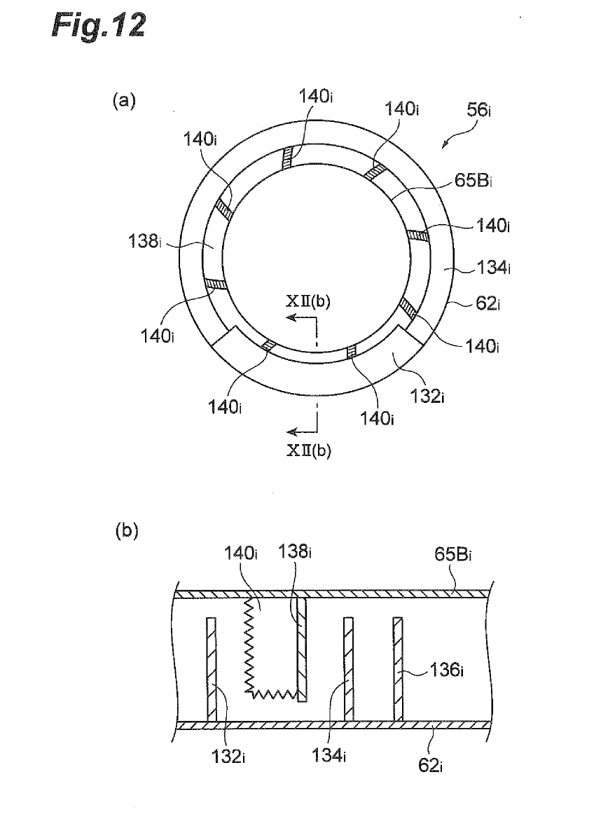

FIGS. 12(a) and 12(b) are diagrams illustrating a modified example of an end part structure of a heating furnace. FIG. 12(a) schematically illustrates a structure in which the second end part 65Bᵢ side of a heating furnace 56ᵢ is seen from the first end part 65Aᵢ side thereof. For explaining the end part structure, FIG. 12(a) mainly illustrates differences from the structure explained with reference to FIGS. 4 and 5. FIG. 12(a) corresponds to a schematic view of a cross-sectional structure orthogonal to the center line Cᵢ. FIG. 12(b) schematically illustrates a cross-sectional structure taken along the line XII(b)-XII(b) of FIG. 12(a). The left and right sides of FIG. 12(b) represent the first end part 65Aᵢ side and end wall 64Bᵢ side, respectively.

In the outer drum part 6Z, the region opposing the second end part 65Bᵢ may be provided with leak prevention plates 132ᵢ, 134ᵢ, 136ᵢ for preventing the aggregates 12 from leaking. The leak prevention plate 132ᵢ is disposed in a predetermined region on the bottom side (the aggregate outlet port 62bᵢ side) of the inner peripheral surface of the outer drum part 62ᵢ. The leak prevention plates 134ᵢ, 136ᵢ circle once around the inner peripheral surface of the outer drum part 62ᵢ.

In the mode equipped with such leak prevention plates 132ᵢ, 134ᵢ, 136ᵢ, an invading aggregate bounce plate 138ᵢ may be disposed on the outer peripheral surface of the second end part 65ᵢ. The invading aggregate bounce plate 138ᵢ may be arranged between the leak prevention plates 132ᵢ, 134ᵢ in the direction of the center line Cᵢ. For example, the invading aggregate bounce plate 138ᵢ may be provided with a plurality of discrete scraper blades 140ᵢ circumferentially (see FIG. 12(a)). For example, assuming the invading aggregate bounce plate 138ᵢ to be the partition 108Bᵢ illustrated in FIG. 9, the scraper blades 140ᵢ may be disposed as with the scraper blades 114Bᵢ arranged for the partition 108Bᵢ. That is, the scraper blades 140ᵢ are disposed on the surface on the leak prevention plate 132ᵢ side of the invading aggregate bounce plate 138ᵢ so as to intersect the invading aggregate bounce plate 138ᵢ(see FIG. 12(b)).

In this structure, the leak prevention plates 132ᵢ, 134ᵢ, 136ᵢ and the invading aggregate bounce plate 138ᵢ can inhibit the aggregates 12 from entering the rear side (the end wall 64Bᵢ side) in the region between the second end part 65Bᵢ and the outer drum part 62ᵢ and staying there. As a result, the inner drum part 60ᵢ is easy to rotate more stably.

In the mode equipped with the scraper blades 140ᵢ, the aggregates 12 between the leak prevention plates 132ᵢ, 134ᵢ are scraped up by the scraper blades 140ᵢ as the inner drum part 60ᵢ rotates. The leak prevention plate 132ᵢ falls short of encircling the outer drum part 62ᵢ but is disposed on the bottom side in the state where the aggregate heating device 20 is installed, whereby the aggregates 12 circumferentially exceeding the leak prevention plate 132ᵢ (i.e., passing the circumferential end part in the leak prevention plate 132ᵢ) after being scraped up by the scraper blades 140ᵢ are returned to the inside in the direction of the center line Cᵢ. This inhibits the space between the leak prevention plates 132ᵢ, 134ᵢ from being clogged with the aggregates 12 staying there. As a result, the inner drum part 60ᵢ is easy to rotate more stably. When scraping up the aggregates 12 with the scraper blades 140ᵢ, it is preferred for the scraper blades 140ᵢ to have serrated side faces and end face (surface on the outer drum part 62ᵢ side) as FIG. 12(b) illustrates.

An opening part for discharging the aggregates 12 flowing there may be provided in the outer drum part 62ᵢ in the region between the two leak prevention plates counted from the end wall 64Bᵢ side in the direction of Cᵢ, i.e., the leak prevention plates 134ᵢ, 136ᵢ in the mode illustrated in FIG. 12(b). It will be sufficient if at least one opening part is formed on the bottom side of the outer drum part 62ᵢ. Preferably, in this case, a mechanism (e.g., chute) for discharging the aggregates 12 is attached to the opening part, so as to discharge the aggregates 12 flowing there. This can further inhibit the aggregates from flowing to the outside of the leak prevention plates 136ᵢ and staying there.

While a modified example of the cross-sectional structure of the end part on the second end part 65Bᵢ side is explained with reference to FIGS. 12(a) and 12(b), a similar structure may also be employed on the first end part 65Aᵢ side. The number and/or form, and the like of leak prevention plates provided in the outer drum part 62ᵢ, the number and/or form, and the like of invading aggregate bounce plates provided in the inner drum part 60ᵢ, states of arrangement of the leak prevention plates and invading aggregate bounce plates, combinations and the like of the leak prevention plates and invading aggregate bounce plates may be modified as appropriate within the scope not deviating from the gist of the present invention. For example, the leak prevention plates 136ᵢ may be omitted.

A modified example of the opening/closing part of the aggregate outlet port will now be explained with reference to the heating furnace part 54 by way of example. As mentioned above, the aggregate outlet port 62b₂ can be opened and closed by sliding the slide plate 102 in a predetermined direction with the opening/closing controller 104 such as an air cylinder (see FIGS. 3 and 5). The slide plate 102 may be connected to the opening/closing controller 104 either directly or through a wire or the like. This easily allows the opening/closing controller 104 to be arranged with such a distance from the heating furnace part 54 as to be uninfluenced by heat leaking from the heating furnace part 54 when the aggregate outlet port 62b₂ is opened or heat transmitted from within the heating furnace part 54 or the aggregates 12 to the slide plate 102. Therefore, the opening/closing controller 104 can be inhibited from being damaged by heat within the heating furnace part 54. When connectors adapted to block thermal conduction are disposed at the connecting part between the opening/closing controller 104 and the wire and the connecting part between the wire and the slide plate 102, heat can further be inhibited from being transmitted from the heating furnace part 54 to the opening/closing controller 104.

The slide plate 102 is explained as a flat plate in the mode illustrated in FIGS. 3 and 5 but may be convex in the flowing direction of the aggregates 12. The slide plate 102 may be arranged such as to cover the lower opening part of the aggregate discharge part 100. In this case, it will be sufficient if the slide plate 102 is swingable about a certain point. While the opening/closing means (opening/closing mechanism) for the aggregate outlet port 62b₂ of the heating furnace part 54 is explained here, a similar modified example is also applicable to the opening/closing means (opening/closing mechanism) for the aggregate outlet port 62b₁ of the heating furnace part 52. Not only the opening/closing means (opening/closing mechanisms) for the aggregate outlet ports 62b₁, 62b₂, but the opening/closing means (opening/closing mechanisms) for the aggregate inlet ports 62a₁, 62a₂ can also be modified in such a manner.

The heating furnace parts 52, 54 may have any inner structures, e.g., inner forms of the end walls 64Aᵢ, 64Bᵢ and positions, sizes, and the like of the aggregate inlet ports 62aᵢ, 62bᵢ as long as the aggregates 12 can efficiently be heated therein. For example, the heating furnace parts 52, 54 equipped with the aggregate guide paths 74ᵢ may be constructed such that the aggregates 12 fed therein are efficiently introduced into the respective aggregate guide paths 74ᵢ.

In the foregoing, the heating device is explained as the aggregate heating device for heating the aggregates 12, while the heating furnaces are explained as the heating furnaces 56₁, 56₂ for heating the aggregates 12. However, the heating furnace having a double structure in which an inner cylindrical part is contained in a cover part and a heating device equipped therewith are not limited to those for heating the aggregates 12 but may be employed for heating other objects. Examples of the other objects include powders from which moistures must be removed, and the heating furnace and heating device in accordance with the present invention are also employable for heating wood and tea leaves. The heating device is not required to comprise two heating furnaces each having the above-mentioned double structure, and one heating furnace may constitute the heating device. When the heating furnace having the double structure in which the inner cylindrical part is contained in the cover part is used alone, the cover part of the heating furnace may comprise opening/closing parts for opening and closing the inlet and outlet ports for letting objects in and out. This allows the cover part to confine heat therein.

Various embodiments and modified examples explained in the foregoing and constituents included therein may be combined to each other as appropriate so as to constitute other embodiments.

### REFERENCE SIGNS LIST

12 . . . aggregate (object); 20, 20A, 20B . . . aggregate heating device (heating device); 52 . . . heating furnace part (first heating furnace part); 54 . . . heating furnace part (second heating furnace part); 56₁, 56₂ . . . heating furnace; 58₁, 58₂ . . . cover part; 60₁, 60₂ . . . inner drum part (inner cylindrical part); 62₁, 62₂ . . . outer drum part (outer cylindrical part); 64A₁, 64B₁ . . . end wall; 64A₂, 64B₂ . . . end wall; 65A₁, 65A₂ . . . first end part; 65B₁, 65B₂ . . . second end part; 66₁, 66₂ . . . connecting member; 69₁, 69₂ . . . opening; 74₁, 74₂ . . . aggregate guide path (object guide path); 76A₁, 76B₁ . . . path wall; 76A₂, 76B₂ . . . path wall; 80 . . . heat source (heat supply part); 82 . . . heat supply pipe (heat supply part); 92 . . . heat supply pipe (heat supply part); Cᵢ . . . center line (predetermined axis)

What is claimed is:

1. A heating device comprising:
a first heating furnace part for heating an object; and
a second heating furnace part for heating the object having passed through the first heating furnace part;
wherein each of the first and second heating furnace parts comprises:
an inner cylindrical part adapted to rotate about a predetermined axis;
a cover part containing the inner cylindrical part therewithin and being capable of confining heat therewithin; and
a heat supply part for supplying the heat into the inner cylindrical part;
wherein the inner cylindrical part includes:
a first end part located on one end side of the predetermined axis;
a second end part located on the other end side of the predetermined axis; and
a plurality of connecting members for connecting the first and second end parts to each other and circulating the object within the inner cylindrical part as the inner cylindrical part rotates,
wherein the plurality of connecting members are discretely arranged circumferentially so as to form an opening between the connecting members adjacent to each other.

2. A heating device according to claim 1, wherein the second heating furnace part is disposed vertically lower than the first heating furnace part.

3. A heating device according to claim 1, wherein each of the first and second heating furnace parts in the heating device comprises an object guide path for guiding the object within the inner cylindrical part; and
wherein the heat supply part in each of the first and second heating furnace parts supplies heat into the object guide path through a heat supply pipe.

4. A heating device according to one of claim 1, wherein one end of the heat supply part in the first heating furnace part is inserted into the first heating furnace part, while the other end of the heat supply part in the first heating furnace part is inserted into the second heating furnace part.

5. A heating device according to one of claim 1, wherein the heat supply part in the second heating furnace part comprises a heat source.

6. A heating device according to claim 5, wherein the heat source generates heat by utilizing electricity.

7. A heating furnace comprising:
an inner cylindrical part adapted to rotate about a predetermined axis;
a cover part containing the inner cylindrical part therewithin and being capable of confining heat therewithin; and
a heat supply part for supplying the heat into the inner cylindrical part;
wherein the inner cylindrical part includes:
a first end part located on one end side of the predetermined axis;
a second end part located on the other end side of the predetermined axis; and
a plurality of connecting members for connecting the first and second end parts to each other and circulating an object within the inner cylindrical part as the inner cylindrical part rotates,
wherein the plurality of connecting members are discretely arranged circumferentially so as to form an opening between the connecting members adjacent to each other.

8. A heating furnace according to claim 7, comprising an object guide path for guiding the object within the inner cylindrical part;
wherein the heat supply part supplies heat into the object guide path through a heat supply pipe.
